(19) United States
(12) Patent Application Publication
(10) Pub. No.: US 2026/0242197 A1
(43) Pub. Date: Aug. 20, 2026

(54) MAST FOR A LOAD LIFTING VEHICLE

(71) Applicant: COMBILIFT, Co Monaghan (IE)

(72) Inventors: Martin MCVICAR, Milltown, Monaghan (IE); Robert MOFFETT, Clontibret, Monaghan (IE); Mark WHYTE, Castleblaney, Monaghan (IE)

(21) Appl. No.: 19/472,342

(22) PCT Filed: Mar. 19, 2024
(86) PCT No.: PCT/EP2024/057211

§ 371 Date: Oct. 3, 2025

(30) Foreign Application Priority Data
Apr. 4, 2023 (GB) 2304958.8

(51) Int. Cl. B66F 9/08; B66F 9/22

(52) U.S. Cl. CPC B66F 9/08; B66F 9/22

(57) ABSTRACT

A load lifting vehicle comprising two opposed rails connected by a base, a carriage configured to move along the rails, a mast cross member configured to move along the rails, a first hydraulic cylinder and second hydraulic cylinders connected to the mast cross member, wherein the first cylinder is configured to move the carriage with respect to the mast cross member and the second cylinders are configured to move the mast cross member, the first cylinder and carriage with respect to the base.

### TECHNICAL FIELD

This invention relates to a mast for a load lifting vehicle.

### BACKGROUND ART

A mast is the vertical assembly on the front of a load lifting vehicle (such as a forklift) that does the work of raising, lowering, and tilting the load.

Attached to the mast is the carriage. Attached to the carriage are the forks. The carriage is usually actuated by a hydraulic cylinder in the middle of the mast. By an operator pulling a lever it raises the carriage by actuating that cylinder, thus lifting the forks (and any load thereon). Known masts lift by hydraulic displacement and lower by the force of gravity.

Free lift is the maximum height that the forks can be raised without changing the mast height. It is important to appreciate mast free lift, especially if there is a desire for stacking or unstacking in confined spaces such as trailers, containers, and racking systems. These applications have height restrictions and might cause product or equipment and possible safety concerns for operators or nearby pedestrians.

There are a number of mast types such as a simplex mast, a duplex mast, triplex mast and quad mast. A simplex mast is the simplest mast type. It is a single stage mast with a single channel. The mast and carriage rise simultaneously. It is built in different sizes to meet various lift heights. This mast has very limited or no free lift and is used for lower lift heights. However, the simplex mast provides very good operation visibility. This is because it has fewer components within it to obstruct the operator's view.

Turing to FIG. 1, this shows a simplex mast 100 in both a lowered and raised position i.e., when the carriage 101 is lowered and raised. It can be seen that even in the lowered position, the lowered height of the mast is relatively high. The lowered height, also known as the collapsed height is the distance from the floor to the top of the mast when the carriage 101 is lowered. As is known in the art, the lowered height is especially important to consider if a vehicle with the mast thereon will be traveling through confined spaces like doorways.

When raised such that the carriage and forks are fully lifted, the extended height of the mast is very high due to the high carriage 101 height and extended cylinder 102. As is known in the art, the extended height is the distance from the floor to the top of the mast when the carriage 101 is fully raised. High extended heights interfere with overhead structures and raises the center of gravity of the mast, which affects stability and capacity of a load lifting vehicle on which the mast may be mounted.

Furthermore, the simplex mast shown in FIG. 1 does not have any free lift and therefore it has limited applications. In addition, this mast requires a relatively long cylinder 102, which can be expensive. Simplex masts are generally used outdoors where overhead clearance isn't a concern.

There is a need for an improved simplex or single stage mast which addresses the drawbacks of the prior art.

### SUMMARY

The present teachings relate to a mast for a load lifting vehicle comprising two opposed rails connected at a base of the mast, a carriage configured to move along the rails, a mast cross member configured to move along the rails, a first hydraulic cylinder and second hydraulic cylinders connected to the mast cross member, wherein the first cylinder is configured to move the carriage with respect to the mast cross member and the second cylinders are configured to move the mast cross member, the first cylinder and carriage with respect to the base of the mast.

This configuration provides free lift to the mast wherein the first cylinder can raise the carriage without increasing the height of the mast. In addition, this configuration is a single stage or simplex mast such that good visibly is provided because of the relatively few components blocking an operator's view of the forks (and load).

Preferably the carriage comprises two opposed sections and a carriage cross member connecting the opposed sections, the two opposed sections shaped to slide within the rails of the mast.

This configuration provides a generally U-shaped carriage and this shape allows the carriage to be raised by the first cylinder i.e., the side section slide past the mast cross member when the first cylinder is actuated.

Preferably a piston rod end of the first cylinder is connected to the carriage cross member and a head of the first cylinder is mounted to the mast cross member.

With this configuration, the first cylinder may be considered to be hanging from the mast cross member, which allows it to move with the carriage i.e., be raised and lowered with the carriage. In addition, by extending and retracting the piston rod the carriage can be raised and lowered with respect to the mast cross member.

The piston rod end of the first cylinder may be connected to the carriage cross member using a spherical rod clevis.

Preferably, the piston rod ends of the second cylinders are connected to the mast cross member and blind ends of the second cylinders are mounted to the base of the mast.

This configuration allows the second cylinders can hold the mast cross member stationary when the first cylinder is extending, retracting etc. Furthermore, this allows the second cylinders to raise and lower the mast cross member when desired which in turn raises the first cylinder and carriage.

A piston rod of the first cylinder is configured to extend to raise the carriage and retract to lower the carriage.

Piston rods of the second cylinders may be configured to extend to raise the mast cross member, the first cylinder and the carriage and retract to lower the mast cross member, the first cylinder and the carriage.

Optionally, the piston rods of the second cylinders are configured to extend only after the piston rod of the first cylinder is fully extended.

This ensures that the height of the mast in only increased after the maximum lift using the first cylinder is achieved.

Optionally, the piston rod of the first cylinder is configured to extend only after the piston rods of the second cylinder are fully extended.

The second cylinders may be configured to hold the mast cross member stationary while the first cylinder moves the carriage with respect to the mast cross member.

Preferably, the carriage cross member connects the two opposed sections at the first end of the carriage and a second end of the carriage, opposite the first end, is open. This allows the carriage to move with respect to the mast cross member.

Preferably, the rails are connected by fixed support members which maintain the rails parallel to each other. These provide support and stability to the mast.

The present teachings also provide another embodiment of a mast for a load lifting vehicle comprising two opposed rails connected by a base of the mast, a carriage configured to move along the rails, a mast cross member configured to move along the rails, two first hydraulic cylinders and a single second hydraulic cylinder connected to the mast cross member, wherein the two first cylinders are configured to move the carriage with respect to the mast cross member and the single second cylinder is configured to move the mast cross member, the first cylinder and the carriage with respect to the base of the mast.

This embodiment works in essentially the same way as the first embodiment and has all the same advantages. Instead of a single centrally mounted cylinder configured to move the carriage with respect to the mast cross member two cylinders mounted adjacent respective rails are provided. Instead of two cylinders adjacent the respective rails configured to move the mast cross member, the first cylinder and the carriage with respect to the base of the mast, a single centrally mounted cylinder is provided to perform the same function.

The embodiments of the mast in accordance with the present teachings provide a relatively low collapsed height, provide free-lift and are cost effective due to the use of relatively basic components well known in the art. Furthermore, the use of these components, in particular the use of the first and second hydraulic cylinders, provides a very reliable configuration. Pulleys or chains are not required, which necessitate more maintenance and can fail. In addition, unlike some prior art configurations a telescopic cylinder is not required and the mast in accordance with the present teachings relies on well-known single stage hydraulic cylinders.

### BRIEF DESCRIPTION OF THE DRAWINGS

The invention will now be illustrated by the following description of embodiments thereof, given by way of example only, with reference to the accompanying drawings, in which:

FIG. 1 shows a known simplex mast in both a lowered and raised position;

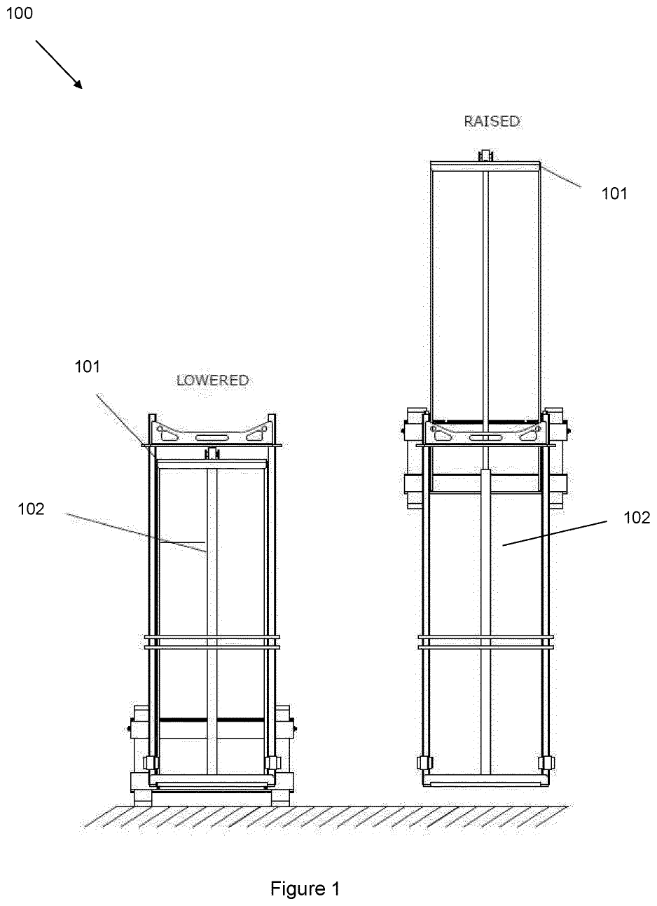

FIG. 2 shows the mast in accordance with the present teachings in a fully lowered position;

FIG. 3 shows the mast in accordance with the present teachings in a semi-raised position;

FIG. 4 shows the mast in accordance with the present teachings in a fully raised position;

FIG. 5 shows side views of the mast in accordance with the present teachings in a fully lowered position, a semi-raised position and a fully raised position; and

FIG. 6 shows further views of the mast in accordance with the present teachings.

### DETAILED DESCRIPTION OF PREFERRED EMBODIMENTS

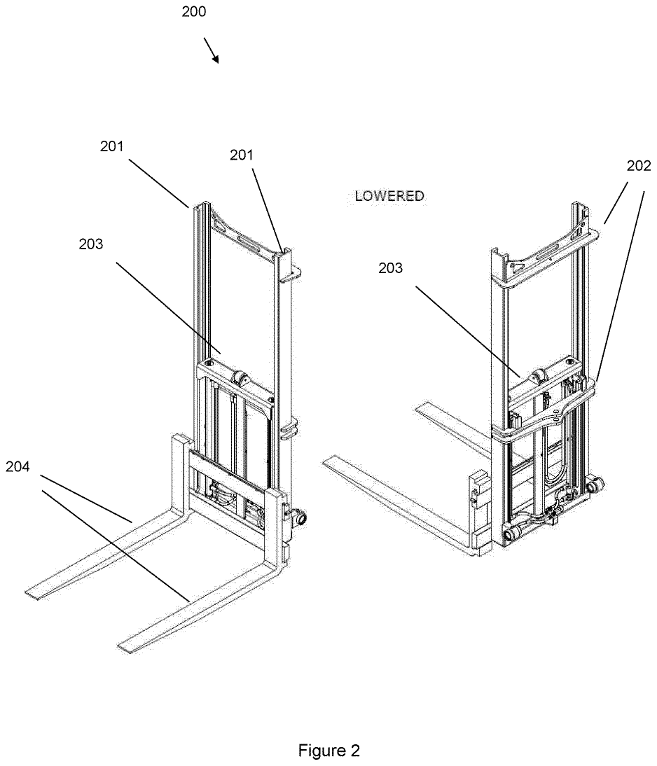

Referring to FIG. 2, this shows the mast 200 in accordance with the present teachings in a lowered position. The mast 200 comprises two opposed rails 201. The rails are connected by fixed support members 202, which keep the rails a fixed distance apart (parallel) and provide support and stability to the mast 200. The mast further comprises a carriage 203 configured to slide within the rails i.e., to move up and down within the opposed rails. For example, the opposed rails may provide channels, which are similar in appearance to I-Beams. The rails provide a guide for the carriage 203 to run in. As is known in the art, forks 204 may be mounted on the carriage.

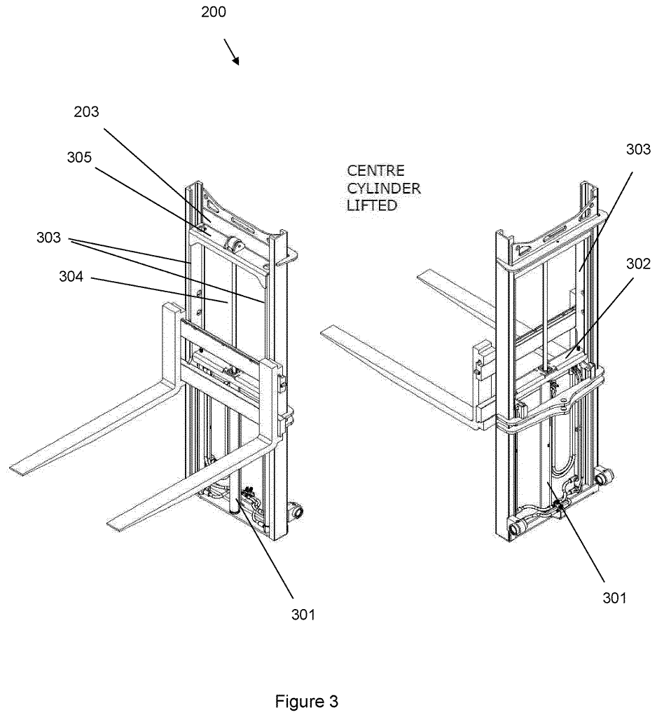

Turning to FIG. 3, this shows the mast 200 in accordance with the present teachings in a semi raised position. This is achieved through the use of a centre cylinder or first cylinder 301. The first cylinder 301 is mounted to a mast cross member 302. The mast cross member spans the distance between the rails 201 and is configured such that side sections 303 of the carriage 203 slide between respective rails 201 and the mast cross member 302. In particular, the head of the first cylinder is mounted to the mast cross member 302 such that a piston rod 304 of the first cylinder passes through the mast cross member 302. The first cylinder 301 is only mounted at the head thereof to the mast cross member such that the bling end of the first cylinder 301 is unmounted or hanging. The first cylinder 301 is positioned centrally i.e., approximately equidistance to each rail 201. The piston rod 304 extending from the first cylinder 301 is connected to a carriage cross member 305. The carriage cross member 305 and the aforementioned side sections 303 connected thereto forming the carriage 203. Specifically, the carriage cross member 305 spans the distance between the rails and connects to each side section 303 at first end of the carriage. A second end of the carriage 203, opposite the first end, is open. When the carriage is fully lowered as shown in FIG. 2 the carriage cross member 305 rests on the mast cross member 302.

Extending the piston rod 304 from the first cylinder raises the carriage 203 by causing it to slide along the rails 201, specifically the side sections 303 slide along the rails. The first cylinder 301 is configured to move the carriage 203 with respect to the mast cross member 302. The forks 204 attached to the carriage 203 rise with the carriage along with any load on the forks. As will be explained hereinafter, the mast cross member 302 is held in place (stationary) when the piston rod 304 of the first cylinder 301 is extending and retracting. In the preferred embodiment, the piston rod 304 of the first cylinder is connected to the carriage cross member 305 using a spherical rod clevis but any known connection means may be used.

It should be appreciated from FIG. 3 that the carriage 203 (and forks 204) can rise to approximately half the height of the mast 200 without increasing the height of the mast. That is, the mast 200 in accordance with the present teachings offers a considerable amount of free lift.

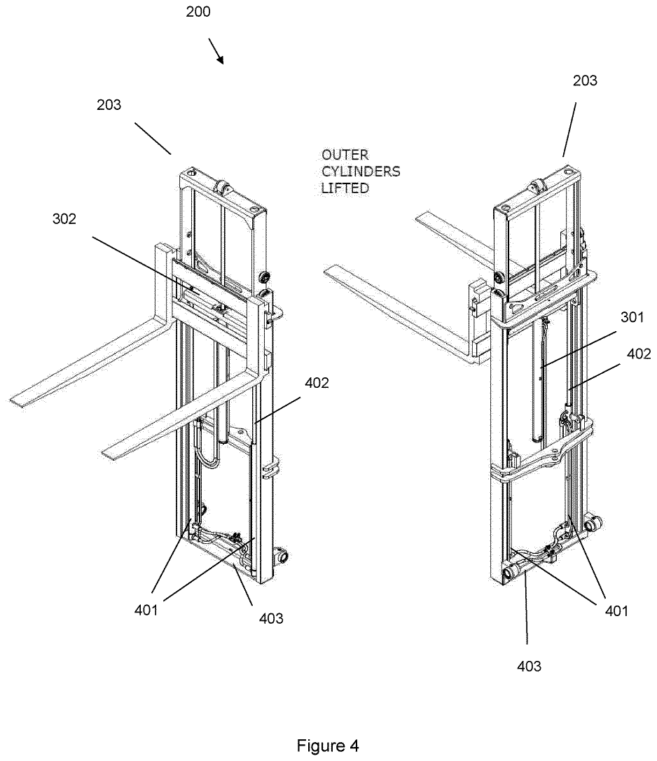

Turning to FIG. 4 this shows the carriage 203 fully raised. This is achieved by two outer cylinders or second hydraulic cylinders 401. Each second cylinder 401 is positioned adjacent a respective rail 201. A piston rod 402 extends from a first end of each second cylinder and connects to the mast cross member 302. The opposite end or second end of each second cylinder 401 is connected to a base 403 of the mast 200. The base 403 connects the two rails 201. The mast is configured such that when the piston rods 402 extend they raise the mast cross member 302 as well as the carriage 203 which is connected to the mast cross member 302 by the first cylinder 301, the first cylinder also being raised by the extension of the second cylinders 401. That is, the carriage 203 is moved with respect to the base 403 of the mast by the second cylinders 401. The mast is configured such that when the second cylinders extend they raise the carriage above the height of the mast 200 i.e., the fully raised carriage increases the height of the mast.

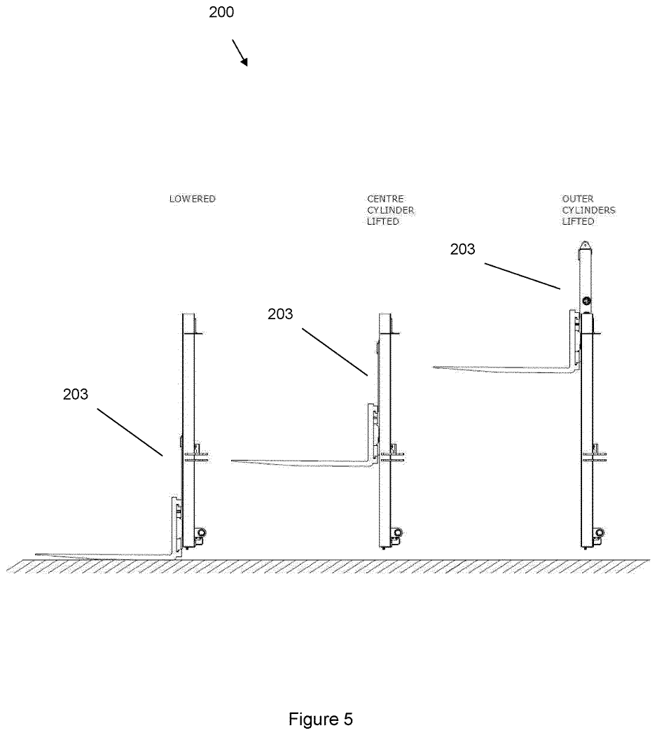

In FIG. 5, the aforementioned free lift capability of the mast 200 in accordance with the present teachings can also be seen. For example, a vehicle such as a forklift with the mast 200 mounted thereon may enter a confined space such as a shipping container and lift a load without increasing the height of mast. Later once, the vehicle has exited the confined space it may raise the load the maximum height for stacking etc.

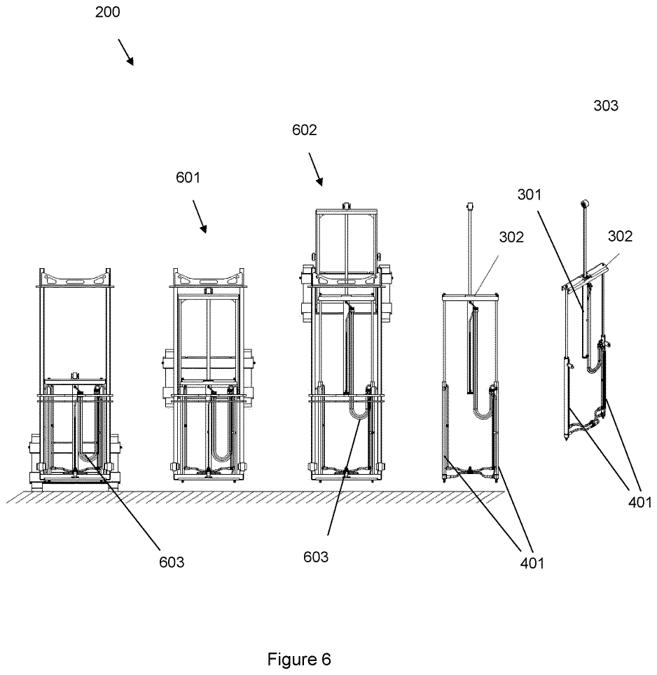

FIG. 6 provides further views of the mast 200 in accordance with the present teachings. The mast be considered to be a two stage mast or a pseudo two stage mast. The first stage 601 is when the first cylinder extends and retracts to raise and lower the carriage 203 with respect to the mast cross member. The second stage 602 is when the second cylinders extend and retract to raise and lower the mast cross member, the carriage and the first cylinder with respect to the base of the mast. The person skilled in the art will appreciate that the second stage can occur 602 before the first stage 601. That is, the second cylinders can raise the carriage before the first cylinder extends. This will still achieve the same free-lift outlined with above wherein the first cylinder extends first.

In FIG. 6, views of only the mast cross member 302 and cylinders 301, 401 are provided to show these components more clearly. The mounting of the first cylinder 301 on the mast cross member 302 can be seen wherein the first cylinder hangs by the head of the first cylinder from the mast cross member 302. The mast cross member 302 and the first cylinder 301 can be raised and lowered by the second cylinders 401. Flexible hydraulic feed lines 603 are provided to accommodate the raising and lowering of the first cylinder 301. In addition, the good visibility provided to an operator of the mast 200 can be observed from FIG. 6.

The person skilled in the art will appreciate that the present teachings are not limited to the configuration shown in FIGS. 2-6 and the hydraulic cylinder positions may be changed. For example two cylinders could be used in place of first cylinder and these cylinders positioned adjacent the rails i.e., two cylinders could be used for the first stage 601. A single cylinder, centrally mounted, could be used for second stage. Essentially, the first cylinder 301 configuration and second cylinders 401 configuration could be swapped. Other variations are possible such as two cylinders for each of the first stage 601 and second stage 602. This could result in all four cylinders being positioned adjacent the rails, which could provide improved visibly in the central area of the mast 200.

The cylinder can be single acting (powered only when extending) or double acting (powered when both extending and retracting).

The invention is not limited to the embodiments described herein which may be varied within the scope of the claims that follow.

1. A mast for a load lifting vehicle comprising:
two opposed rails connected by a base;
a carriage configured to move along the rails;
a mast cross member configured to move along the rails;
a first hydraulic cylinder and second hydraulic cylinders connected to the mast cross member;
wherein the first cylinder is configured to move the carriage with respect to the mast cross member and the second cylinders are configured to move the mast cross member, the first cylinder and carriage with respect to the base.

2. The mast according to claim 1 wherein the carriage comprises two opposed sections and a carriage cross member connecting the opposed sections, the two opposed sections shaped to slide within the rails of the mast.

3. The mast according to claim 2 wherein a piston rod end of the first cylinder is connected to the carriage cross member and a head of the first cylinder is mounted to the mast cross member.

4. The mast according to claim 3 wherein the piston rod end of the first cylinder is connected to the carriage cross member using a spherical rod clevis.

5. The mast according to claim 1 wherein piston rod ends of the second cylinders are connected to the mast cross member and blind ends of the second cylinders are mounted to the base.

6. The mast according to claim 1 wherein a piston rod of the first cylinder is configured to extend to raise the carriage and retract to lower the carriage.

7. The mast according to claim 6 wherein piston rods of the second cylinders are configured to extend to raise the mast cross member, the first cylinder and the carriage and retract to lower the mast cross member, the first cylinder and the carriage.

8. The mast according to claim 7 wherein the piston rods of the second cylinders are configured to extend only after the piston rod of the first cylinder is fully extended.

9. The mast according to claim 7 wherein the piston rod of the first cylinder is configured to extend only after the piston rods of the second cylinders are fully extended.

10. The mast according to claim 1 wherein the second cylinders are configured to hold the mast cross member stationary while the first cylinder moves the carriage with respect to the mast cross member.

11. The mast according to claim 2 wherein the carriage cross member connects the two opposed sections at the first end of the carriage and a second end of the carriage, opposite the first end, is open.

12. The mast according to claim 1 wherein the rails are connected by fixed support members which maintain the rails parallel to each other.

13. A mast for a load lifting vehicle comprising:
two opposed rails connected by a base;
a carriage configured to move along the rails;
a mast cross member configured to move along the rails;
two first hydraulic cylinders and a single second hydraulic cylinder connected to the mast cross member;
wherein the two first cylinders are configured to move the carriage with respect to the mast cross member and the single second cylinder is configured to move the mast cross member, the first cylinder and the carriage with respect to the base.
